(19) United States
(12) Patent Application Publication
(10) Pub. No.: US 2002/0199168 A1
(43) Pub. Date: Dec. 26, 2002

(54) Automatic program generation apparatus

(75) Inventor: Masayoshi Namito, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Mitsubishi Denki Kabushiki Kaisha, Tokyo (JP)

(21) Appl. No.: 10/013,452

(22) Filed: Dec. 13, 2001

(30) Foreign Application Priority Data
Jun. 25, 2001 (JP) 2001-191235

(51) Int. Cl. G06F 9/44

(52) U.S. Cl. 717/107

(57) ABSTRACT

To obtain an automatic program generation apparatus automatically generating an application program of uniform quality independent of a personal ability of a designer or a model of a process control computer, and printing standardized specifications with design contents correctly described. The apparatus includes: specification storage units for storing specifications which are to become samples; program information input units for inputting in a table format application program information about a production process control computer; a program generation unit for generating a source code of each application program according to input information; and a specifications completion unit for editing the specifications according to the input information, and completing the specifications corresponding to each application program.

### BACKGROUND OF THE INVENTION

1. Field of the Invention

The present invention relates to an automatic program generation apparatus capable of automatically generating a program for the process of production with uniform quality, and printing standardized specifications perfectly corresponding to the generated program.

2. Description of the Related Art

Generally, in the process of production in a number of industries such as a steel industry, etc., plural types of products are produced in a plurality of different processes. Generally, such production processes are controlled by an exclusively developed process control computer.

FIG. 6 is a block diagram of an entire configuration of the conventional process of production using the process control computer.

In FIG. 6, reference numeral 10 denotes a process control computer for controlling an actual operation of the process of production in a factory 20. The process control computer 10 is connected to a terminal 25 such as a personal computer through a network, and an instruction to the process control computer 10 from an operator 24, a report of a control result by the process control computer 10, etc. are transmitted through the terminal 25.

The process control computer 10 receives the flow of products during the operation as tracking information from an electric measure 21 provided in equipment 23 of the factory 20 through a tracking function 11 inside the process control computer 10, and receives the process data of the operation result from the electric measure 21 and a instrumentation measure (various sensors, etc.) 22. The received tracking information is transmitted to a screen and listing input/output function 13 through result collecting and operation managing functions 12, and the result data is accumulated as a process data file 14 through the result collecting and operation managing functions 12.

The above mentioned process is performed for each step of a series of processes of production. At this time, the set screen displayed on the CRT 25 in each step is unique to receive unique set data. The operator 24 inputs a command on the set screen, issues a predetermined instruction to the process control computer 10, and controls the operation of the factory 20.

Each of these functions requires a corresponding and appropriate application program. However, the application program has conventionally been generated depending on the personal ability of a program designer. When an application program is completed, each user is normally presented with an object code of the program and an operation manual, and operates the application program according to the operation manual. When it is detected that the application program cannot normally operate, the program can be correctly maintained to realize the normal operation of the program. When the program is completed, a source code list, documents indicating the contents of the design, etc. have to be manually generated, thereby requiring laborious work and needing improving.

On the other hand, in the process control computer, the system configuration of a CPU, an OS, etc. has been changed with time, and the change of the system configuration needs regenerating the application software which has the same function and is written in the same language so that the application software can meet the difference in system call depending on the model, thereby requiring a long time to amend the software.

The process contents of a normally operating application program often have to be changed with time and depending on the user changing the contents of the business. In the conventional devices, there has been the problem that a complete application program cannot be easily changed.

That is, when there is no source code list of a program, or when the source code list does not correspond to the object code after the program is appropriately maintained, etc., only a small change of the process contents of an application program requires a very long time, and there can be the possibility that the program has to be newly generated.

Furthermore, even if there is a complete source code list, each program contains an element of the personality of the designer of the program depending on the ability, skill, etc. of the designer. Therefore, a third party cannot easily understand the contents of the process, and takes a long time in changing the process contents, thereby possibly inviting the poor function of the entire system due to the change of the program.

Additionally, although there are various documents, etc., they do not always correctly describe the actual process contents in many cases. If they correctly describe the actual process contents, they are described in the completely different formats. Therefore, the third party have difficulty in understanding the contents of the program.

Since it is indispensable to change an application program with time, a program provided for a user should be easily amended or supplemented. Practically, an application program should be uniform in quality independent of the personal ability of the designer, and the process contents of the program provided for the user should be correctly understood by any user. Furthermore, since a process control computer changes with time, an application program independent of the model is to be provided.

### SUMMARY OF THE INVENTION

The present invention has been achieved to solve the above mentioned problems, and aims at providing an automatic program generation apparatus capable of automatically generating an application program having uniform quality independent of the personal ability of a designer or the model of a process control computer, and printing standardized specifications correctly describing the design contents.

The automatic program generation apparatus according to claim 1 of the present invention includes specification storage means storing samples of specifications, program information input means for inputting in a table format the application program information about a production process control computer, program generation means for generating a source code of each application program according to the input information, and specifications completion means for editing the specifications according to the input information, and completing the specifications corresponding to each application program.

The automatic program generation apparatus according to claim 2 of the present invention includes specification storage means storing samples of specifications, program information input means for inputting as specifications the information about the system specifications of a production process control computer, program generation means for generating a source code of each application program according to the input information, and specifications completion means for editing the samples of specifications according to the input information, and completing the specifications corresponding to each application program.

In the automatic program generation apparatus according to claim 3, the program generation means generates a source code of each application program corresponding to various operation system or the central processing unit according to the input information.

In the automatic program generation apparatus according to claim 4, the program generation means generates a source code of each application program according to the input information, program generation means for generating a source code of each application program corresponding to various operation system or the central processing unit according to the input information.

The automatic program generation apparatus according to claim 5 of the present invention includes a program generating method database storing a method for automatically generating each source to absorb the difference in the operation system or the central processing unit.

The automatic program generation apparatus according to claim 6 includes output means for appropriately operating in response to an operation, and printing the complete specifications and a source code list of an application program.

### BRIEF DESCRIPTION OF THE DRAWINGS

FIG. 1 is a block diagram of an automatic program generation apparatus according to a first embodiment of the present invention;

FIG. 2 is a block diagram roughly showing each of functions of the automatic program generation apparatus according to the first embodiment of the present invention;

FIG. 3 is a block diagram roughly showing each of the functions of the automatic program generation apparatus according to a second embodiment of the present invention;

FIG. 4 is a block diagram roughly showing each of the functions of the automatic program generation apparatus according to a third embodiment of the present invention;

FIG. 5 is a block diagram roughly showing each of the functions of the automatic program generation apparatus according to a fourth embodiment of the present invention; and

FIG. 6 is a block diagram of an entire configuration of the process of production using the conventional process control computer.

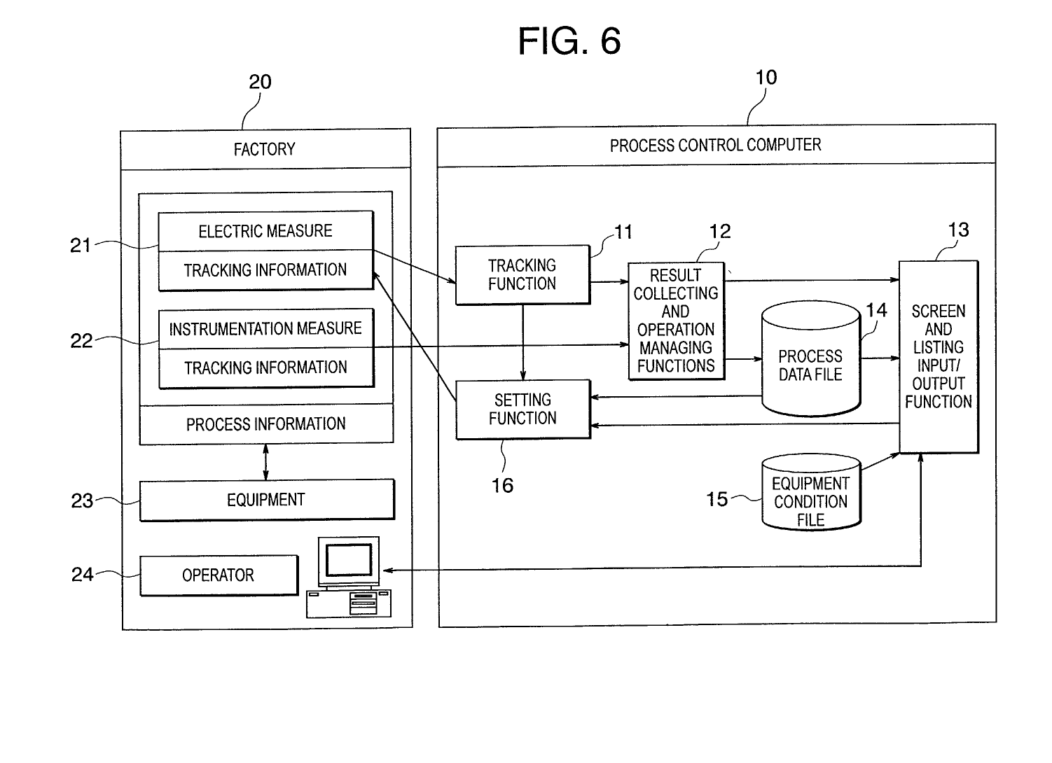

### DETAILED DESCRIPTION OF THE PREFERRED EMBODIMENTS

To attain the above mentioned purposes, the automatic program generation apparatus according to the present invention includes as described later in detail: (1) specification storage means storing samples of specifications; (2) individual information input means (program information input means) for operating when an application program is designed, and receiving in a table input format different pieces of individual information for each application program; (3) a program generation means for generating each program source code according to the input individual information; (4) specifications completion means for editing the specifications according to the input individual information, and completing the specifications corresponding to each application program; and (5) output means for appropriately functioning in response to the operations of other means, and printing a source code list of the completed application program and the specifications.

The present invention practically stores automatic program generation means for each sample of specifications. According to the individual information input in a table format, the sample of specifications can be edited to perfectly correspond to each application program. Since the samples of specifications can be classified into six types, it is easy to standardize the format of specifications and description items. Furthermore, since specifications are standardized, the third party can easily understand them.

The embodiments of the present invention will be described below by referring to the attached drawings.

Embodiment 1

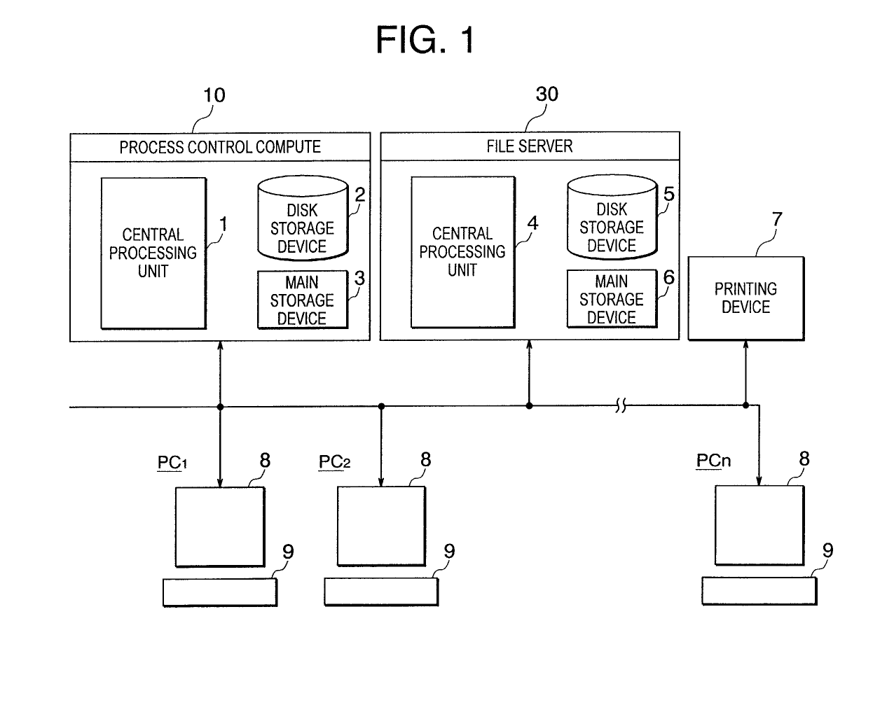

FIG. 1 is a block diagram of the automatic program generation apparatus according to Embodiment 1 of the present invention.

In FIG. 1, the automatic program generation apparatus mainly comprises the process control computer 10, a file server 30, and terminal personal computers PC 1 to PC n. The process control computer 10 comprises a central processing unit 1, a disk storage device 2, a main storage device 3, etc. The file server 30 comprises a central processing unit 4, a disk storage device 5 as specifications storage means storing the samples of specifications, a main storage device 6, etc. The terminal personal computers PC 1 to PC n are input/output terminals comprising a CRT display 8, a keyboard 9, etc., and a printing device 7 is connected to them as necessary. The printing device 7 as output means is connected through a network, and can print data from each of the process control computer 10, the file server 30, and the terminal personal computers PC 1 to PC n.

The automatic program generation apparatus shown in FIG. 1 dynamically generates a source code and an object code of an application program only by proceeding with the procedure of designing the reception and transmission files of settings, results, etc. of a plant, the tracking of processes, the alarm files, the screen files, the listing files, the database, etc. by inputting data in a table format through the terminal personal computers PC 1 to PC n. Additionally, a source code list completely corresponding to the generated object code, and various types of specifications (alarm specifications, tracking specifications, mail specifications, screen file specifications, database specifications, etc.) completely corresponding to the object code can also be printed. A program language is not specifically limited, but various languages such as the C language, the C++ language, the JAVA (registered trademark) language, etc. can be used. In the present embodiment, the generation of an application program in the C language will be described below.

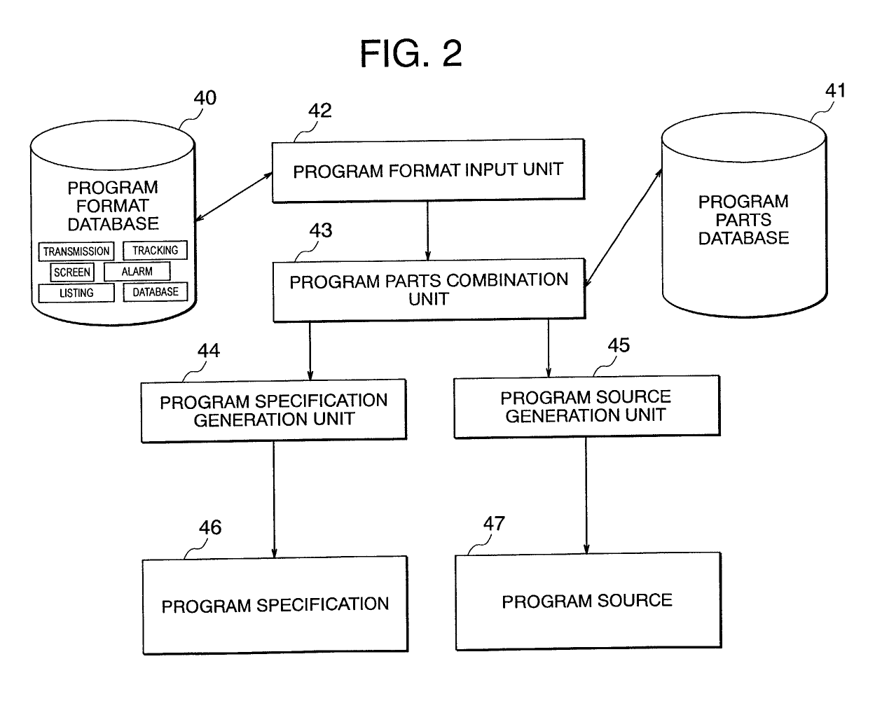

FIG. 2 is a block diagram roughly showing each function of the automatic program generation apparatus according to Embodiment 1.

In the automatic program generation apparatus shown in FIG. 1, the program directs the disk storage device 5 to store six program format databases 40 and n program parts databases 41 to realize the above mentioned processes. The six program formats are fixed formats of transmission, tracking, screen, listing, alarm, and database defined for each function. By inputting the important portion of each function by a program format input unit 42 into the formats, it can be automatically generated as a function.

A program parts combination unit 43 associates the program parts group from the program parts database 41 as automatic program generation means with the function generated by the program format input unit 42 in an interactive mode through the terminal personal computers PC 1 to PC n. The program format input unit 42 and the program parts combination unit 43 form program information input means. The associated program parts group and function are automatically generated as a program specification 46 by a program specification generation unit 44 as specifications completion means. On the other hand, a program source generation unit 45 as program generation means regenerates the associated program parts group and function as a program source 47 available to the process control computer 10.

A program parts group is a source program in a half-completed state storing a procedure necessary to use the function of each of the generated functions, and comprises an individual portion to be changed in each individual process and a body portion not to be changed. The individual portion is determined according to the information input from the keyboard 9 at the program designing stage.

Since each input table and program parts group are high quality programs generated by a skilled programmer, and the program designer inputs a table through a personal computer terminal PC and each program parts group in an interactive mode on the window display, a beginner can easily and quickly complete a high quality application program by using the automatic program generation apparatus according to Embodiment 1. Furthermore, in the automatic program generation apparatus according to Embodiment 1, all programs are formed by a combination of an input format and a program parts group. Therefore, the formats of various types of specifications can be standardized, and can be stored in the disk storage device 5 in the half-completed state. As a result, if an application program is completed, various specifications corresponding to the program can be printed on the printing device 7. Since the formats of the specifications are standardized, any user can easily and correctly understand the contents of the process of the application program.

Conventionally, various specifications cannot be provided for users, or although they are provided for the users, they do not completely correspond to the program. However, according to Embodiment 1, specifications completely corresponding to an application program are provided. Therefore, the application program can be easily amended and changed by any user, thereby further enhancing the value of the application program provided for users.

Embodiment 2

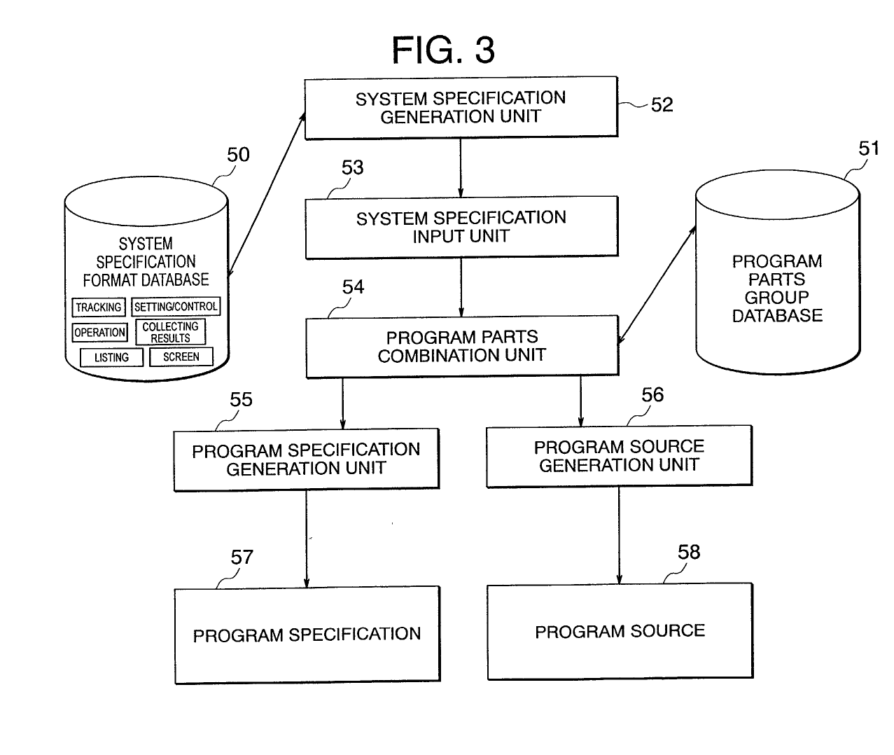

FIG. 3 is a block diagram roughly showing the functions of the automatic program generation apparatus according to Embodiment 2 of the present invention. The hardware configuration according to Embodiment 2 is the same as the configuration shown in FIG. 1.

In FIG. 3, a system specification generation unit 52 inputs data using a system specification format database 50. The data is input by a system specification input unit 53 into a program parts combination unit 54, and the program parts combination unit 54 adds the program parts group in a program parts group database 51. The system specification generation unit 52, the system specification input unit 53, and the program parts combination unit 54 configure the program information input means. Then, a program specification generation unit 55 as specifications completion means automatically generates a program specification 57, and a program source generation unit 56 as program generation means automatically generates a program source 58.

To realize the above mentioned functions, the system specification generation unit 52 stores the formatted system specifications in the system specification format database 50 to realize the six functions, that is, tracking, setting and control, operation management, result collection, listing, and screen functions. The system specification format is formed by a fixed format and a free format. The common function portion of each plant system is described in a fixed format, and the unique portion of each plant system is described in a free format.

The system specification input unit 53 reads information required to generate a program from the fixed format, and automatically generates an important portion of the program. Then, the program parts combination unit 54 combines necessary parts in generating a program in an interactive mode. An application program source and a program specification can be automatically generated only by proceeding with the above mentioned procedures.

Embodiment 3

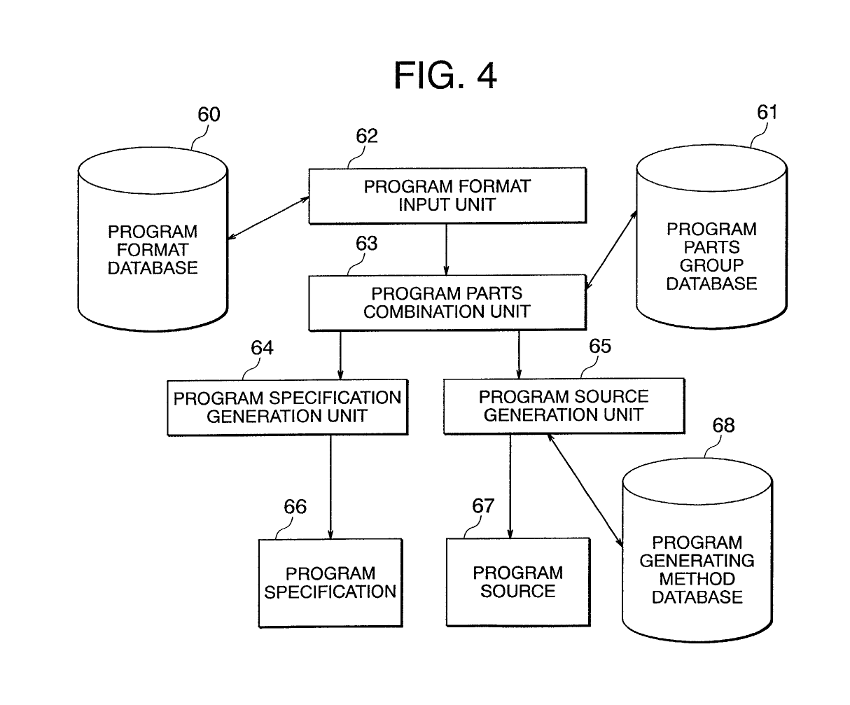

FIG. 4 is a block diagram roughly showing the functions of the automatic program generation apparatus according to Embodiment 3 of the present invention. The hardware configuration according to Embodiment 3 can be the same as the configuration shown in FIG. 1.

According to Embodiment 3, the method of generating a program corresponding to each of various OSs and CPUs is independently stored for each type, thereby satisfying various system environments.

To realize the above mentioned process, the automatic program generation apparatus shown in FIG. 4 stores six program format databases 60 and a program parts group database 61 in the disk storage device 5. The six program formats are fixed for each of the transmission, tracking, screen, listing, alarm, and database defined for each function. By a program format input unit 62 inputting the important portion of each function into the formats, it can be automatically generated as a function.

A program parts combination unit 63 associates the program parts group from the program parts group database 61 with the function generated by the program format input unit 62 through the terminal personal computers PC 1 to PC n in the interactive mode. The program format input unit 62 and the program parts combination unit 63 form program information input means. The associated program parts group and function are automatically generated as a program specification 66 by a program specification generation unit 64 as specifications completion means.

On the other hand, a program source generation unit 65 as program generation means regenerates the associated program parts group and function as a program source 67 available to the process control computer 10. Since the program source generation unit 65 stores an automatically generating method independently for each source in a program generating method database 68 to absorb the difference in OS and CPU, a programmer can generate an application without considering the difference in coding method due to the difference in each OS or CPU, thereby largely saving time.

The program parts group is a source program in a half-completed state storing a procedure required to use the function of each of the generated functions, and comprises an individual portion to be changed for each individual process and a body portion not to be changed. The individual portion is determined by the information input from the keyboard 9 at the program designing stage.

Since each input table and program parts group are high quality programs generated by a skilled programmer, and the program designer inputs a table through a personal computer terminal PC and each parts group in an interactive mode on the window display, a beginner can easily and quickly complete a high quality application program by using the automatic program generation apparatus according to Embodiment 3. On the other hand, since each of the automatically generating methods is independently stored for each source to absorb the difference in OS and CPU, a programmer can generate an application without considering any difference in coding method due to the difference in each OS or CPU, thereby largely saving time.

Furthermore, in the automatic program generation apparatus according to Embodiment 3, all programs are formed by a combination of an input format and a program parts group. Therefore, the formats of various types of specifications can be standardized, and can be stored in the disk storage device 5 in the half-completed state. As a result, if an application program is completed, various specifications corresponding to the program can be printed on the printing device 7. Since the formats of the specifications are standardized, any user can easily and correctly understand the contents of the process of the application program.

Conventionally, various specifications cannot be provided for users, or although they are provided for the users, they do not completely correspond to the program. However, according to Embodiment 3, specifications completely corresponding to an application program are provided. Therefore, the application program can be easily amended and changed by any user, thereby further enhancing the value of the application program provided for users.

Embodiment 4

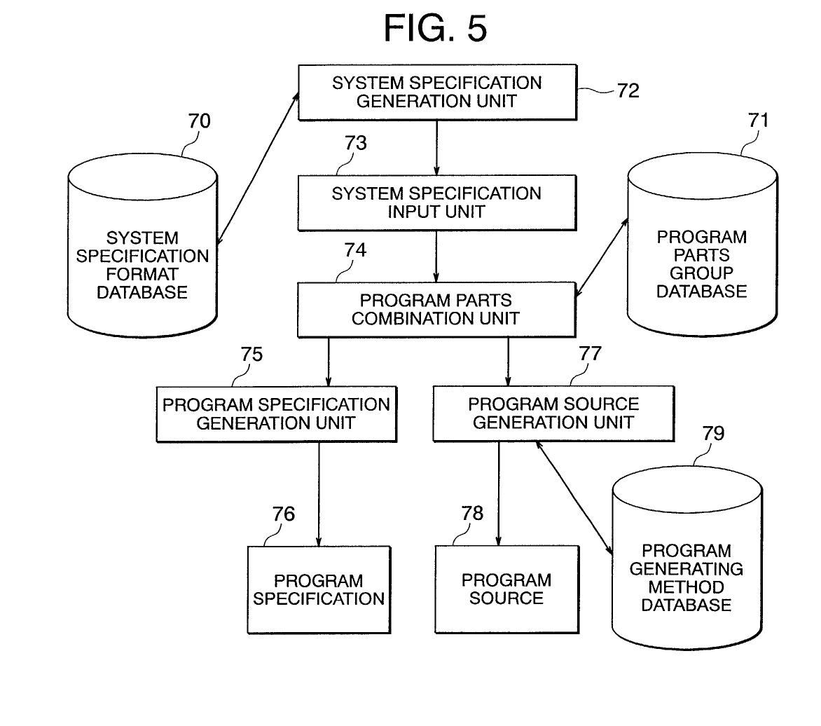

FIG. 5 is a block diagram roughly showing the functions of the automatic program generation apparatus according to Embodiment 4 of the present invention. The hardware configuration according to Embodiment 4 is the same as the configuration shown in FIG. 1.

According to Embodiment 4, a system specification can be input to automatically generating a program corresponding to various OSs and CPUs.

In the automatic program generation apparatus shown in FIG. 5, the program directs the disk storage device 5 to store six system specification format databases 70 and n program parts databases 71 to realize the above mentioned processes. A system specification generation unit 72 inputs data using the system specification format databases 70. The data is input by a system specification input unit 73 into a program parts combination unit 74. The program parts combination unit 74 adds the program parts group in the program parts group database 71. The system specification generation unit 72, the system specification input unit 73, and the program parts combination unit 74 form program information input means.

The six system specification formats are fixed formats of transmission, tracking, screen, listing, alarm, and database defined for each function. By inputting the important portion of each function into the formats, it can be automatically generated as a function.

The program parts combination unit 74 associates the program parts group from the program parts group database 71 with the function generated by the system specification input unit 73 through the terminal personal computers PC 1 to PC n in an interactive mode. The associated program parts group and function are automatically generated as a program specification 76 by a program specification generation unit 75 as specifications completion means.

On the other hand, a program source generation unit 77 as program generation means regenerates the associated program parts group and function as a program source 78 available to the process control computer 10. Since the program source generation unit 77 stores an automatically generating method independently for each source in a program generating method database 79 to absorb the difference in OS and CPU, a programmer can generate an application without considering the difference in coding method due to the difference in each OS or CPU, thereby largely saving time.

The program parts group is a source program in a half-completed state storing a procedure required to use the function of each of the generated functions, and comprises an individual portion to be changed for each individual process and a body portion not to be changed. The individual portion is determined by the information input from the keyboard 9 at the program designing stage.

Since each input table and program parts group are high quality programs generated by a skilled programmer, and the program designer inputs a table through a personal computer terminal PC and each parts group in an interactive mode on the window display, even a beginner can easily and quickly complete a high quality application program by using the automatic program generation apparatus according to Embodiment 4. On the other hand, since each of the automatically generating methods is independently stored for each source to absorb the difference in OS and CPU, a programmer can generate an application without considering the difference in coding method due to the difference in each OS or CPU, thereby largely saving time.

Furthermore, in the automatic program generation apparatus according to Embodiment 4, all programs are formed by a combination of an input format and a program parts group. Therefore, the formats of various types of specifications can be standardized, and can be stored in the disk storage device 5 in the half-completed state. As a result, if an application program is completed, various specifications corresponding to the program can be printed on the printing device 7. Since the formats of the specifications are standardized, any user can easily and correctly understand the contents of the process of the application program.

Conventionally, various specifications cannot be provided for users, or although they are provided for the users, they do not completely correspond to the program. However, according to Embodiment 4, specifications completely corresponding to an application program are provided. Therefore, the application program can be easily amended and changed by any user, thereby further enhancing the value of the application program provided for users.

What is claimed is:

1. An automatic program generation apparatus, comprising:
specification storage means for storing specifications which are to become samples,
program information input means for inputting application program information about a production process control computer in a table format;
program generation means for generating a source code of each application program according to the input information, and
specifications completion means for editing the specifications according to the input information, and completing specifications corresponding to each application program.

2. An automatic program generation apparatus, comprising:
specification storage means for storing specifications which are to become samples;
program information input means for inputting, as specifications as is, information about system specifications of a production process control computer;
program generation means for generating a source code of each application program according to the input information; and
specifications completion means for editing the specifications which are to become samples according to the input information, and completing specifications corresponding to each application program.

3. The apparatus according to claim 1, wherein said program generation means generates a source code of each application program corresponding to various operation system or a central processing unit according to the input information.

4. The apparatus according to claim 2, wherein said program generation means generates a source code of each application program corresponding to various operation system or a central processing unit according to the input information.

5. The apparatus according to claim 3, further comprising a program generating method database independently storing a method for automatically generating each source to absorb a difference in the operation system or the central processing unit is provided.

6. The apparatus according to claim 4, further comprising a program generating method database independently storing a method of automatically generating each source to absorb the difference in the operation system or the central processing unit is provided.

7. The apparatus according to claim 1, further comprising output means for appropriately operating in response to an operation, and printing the complete specifications and a source code list of an application program.

8. The apparatus according to claim 2, further comprising output means for appropriately operating in response to an operation, and printing the complete specifications and a source code list of an application program.
